(19) United States
(12) Patent Application Publication
(10) Pub. No.: US 2021/0281616 A1
(43) Pub. Date: Sep. 9, 2021

(54) User Equipment and Method of Image Sensor Communication of Same

(71) Applicant: GUANGDONG OPPO MOBILE TELECOMMUNICATIONS CORP., LTD., Dongguan (CN)

(72) Inventor: Hirotake Cho, Yokoham (JP)

(21) Appl. No.: 17/330,291

(22) Filed: May 25, 2021

Related U.S. Application Data
(63) Continuation of application No. PCT/CN2018/117487, filed on Nov. 26, 2018.

(51) Int. Cl. H04L 29/06; H04W 12/08; G06F 21/60; G06F 21/36

(52) U.S. Cl. CPC H04L 65/1069; H04L 65/1096; G06F 21/36; H04W 12/08; G06F 21/606; H04L 65/4015

(57) ABSTRACT

A user equipment (UE), and a method of an image sensor communication of same are provided. The method of an image sensor communication of the UE includes receiving a first temporal identification data (ID) allocated from a server, sending a first temporal ID as a light pulse, capturing light pulses of temporal IDs from another UEs, showing a label on a display device corresponding to the temporal IDs of another UEs, sending an inviting message with the first temporal ID and the temporal ID of another UE to a server in radio band when receiving an inviting instruction of a user, and showing an accepting figure corresponding to the label of the temporal ID of another UE on the display device after receiving an accepting message from the server.

### CROSS-REFERENCE TO RELATED APPLICATION(S)

This application is a continuation application of International Application No. PCT/CN2018/117487, filed on Nov. 26, 2018, the entire contents of which are incorporated herein by reference.

### TECHNICAL FIELD

The present disclosure relates to the field of communication systems, and more particularly, to a user equipment (UE) and a method of image sensor communication of same.

### BACKGROUND

In current communication technology, for example, the Session Initiation Protocol (SIP) is a signal protocol used for initiating, maintaining, and terminating real-time sessions that include voice, video and messaging applications, as shown in FIG. 1. SIP is used for signal and controlling multimedia communication sessions in applications of Internet telephony for voice and video calls, in private IP telephone systems, in instant messaging over Internet Protocol (IP) networks as well as mobile phone calling over LTE (VoLTE).

Japanese Patent No. 4867515B2 disclosed an image processing apparatus for superimposing displaying the information of the image and the character or the like obtained by photography or the like. It discloses that CPU 20 in accordance controls and modulates the light source driving unit 22 to drive the light emitting portion 12 by changing in luminance. Thus, information of the message memory 21 is transmitted by the luminance change pattern of light from the light emitting portion 12 (step S13). It also discloses recognizing the outline of the face of the person to be registered, then set the region except the recognized contour portion as a data display frame candidate (step S313).

Japanese Patent No. JP4303087B2 disclosed a technique to transmit data signals using visible light and captures an image including said data signal using a camera for receiving the data signal and detecting the area of the data signals from the video. It discloses a data signal transmission method in a data signal transmission system having a chromatic flashing signal transmitter and a chromatic displayer. The chromatic flashing signal transmitter processes the data to convert the data to a difference of hue value.

Japanese Patent application NO. 2016149673A disclosed a server, a communication connection management method, and a communication connection management program of the short-range wireless communication. It discloses that the generating unit 20 generates a communication ID and token for use in short-range wireless communication between the first terminal 200a and the second terminal 200b (S46).

There has no technology to realizing instant communication among people who do not know each other under a circumstance where voice or gestures cannot reach. Although an Image sensor communication (ISC) system currently uses visible light pulse or light chromatic change for transmitting data, but the transmission rate of ISC is low.

It would still be a need to provide a communication system for Users able to view each other but do not know phone-number or IP-address to each other and do not want to reconnect after communicating.

### SUMMARY

An object of the present disclosure is to propose a user equipment (UE), and a method of image sensor communication of same capable of providing a communication with Users able to view each other but do not know phone-number or IP-address to each other and do not want to reconnect after communicating.

In a first aspect of the present disclosure, a user equipment (UE) includes a light emitter, a pulse driver coupling to the light emitter, an image sensor, a display device, a transceiver, and a processor coupling to the pulse driver, the image sensor, the transceiver, and the display device. The processor is configured to control the pulse driver to drive the light emitter to send a first temporal identification data (ID) as a light pulse, control the image sensor to receive temporal IDs light pulses from another UEs, control the transceiver to transmit a communication message with the first temporal ID and one of the temporal IDs of another UEs to a server in radio band or to receive the communication message with the temporal ID of another UE in radio band, and compare the second temporal ID form the image sensor and the second temporal ID form the transceiver and control the display device to show the communication message corresponding to the second temporal ID.

In a second aspect of the present disclosure, a method of an image sensor communication of a user equipment (UE) includes receiving a first temporal identification data (ID) allocated from a server, sending a first temporal ID as a light pulse, capturing light pulses of temporal IDs from another UEs, showing labels on a display device corresponding to the temporal IDs, sending an inviting message with the first temporal ID and one of the temporal IDs of another UEs to a server in radio band when receiving an inviting instruction of a user, and showing an accepting figure corresponding to the label of the temporal ID of another UE on the display device after receiving an accepting message from the server.

In a third aspect of the present disclosure, a method of an image sensor communication system of a user equipment (UE) with a server includes allocating a first temporal identification data (ID) to the UE by the server, receiving the first temporal ID by the UE in radio band, sending a first temporal ID as a light pulse by the UE, capturing light pulses of temporal IDs from another UEs by the UE, showing a label on a display device corresponding to the temporal IDs of another UEs by the UE, sending an inviting message with the first temporal ID and one of the temporal IDs of another UEs by the UE to the server in radio band when receiving an inviting instruction of a user by the UE, and showing an accepting figure corresponding to the label of the temporal ID of another UE on the display device by the UE after receiving an accepting message from the server.

In a fourth aspect of the present disclosure, a method of an image sensor communication system of a first user equipment (UE), a second UE, and a server includes allocating a first temporal identification data (ID) to the first UE by the server, allocating a second temporal identification data (ID) to the second UE by the server, receiving the first temporal ID by the first UE in radio band, receiving the second temporal ID by the second UE in radio band, sending the first temporal ID as a light pulse by the first UE, capturing the light pulse of the first temporal ID by the second UE, sending the second temporal ID as a light pulse by the second UE, capturing the light pulse of the second temporal ID by the first UE, showing a label on a display device corresponding to the second temporal ID by the first UE, showing a label on a display device corresponding to the first temporal ID by the second UE, sending an inviting message with the first temporal ID and the second temporal ID to the server in radio band when receiving an inviting instruction of a user by the first UE, transmitting the inviting message with the first temporal ID to the second UE by the server in radio band, showing an inviting figure corresponding to the label of the first temporal ID on the display device by the second UE, sending an accepting message to the server after receiving an accepting instruction of the user by the second UE, transmitting the accepting message to the first UE by the server, and showing an accepting figure corresponding to the label of the second temporal ID on the display device by the first UE after receiving an accepting message from the server.

In the embodiment of the present disclosure, the processor is configured to send the inviting message, the first temporal ID, and the second temporal ID accompanying with a notification mode indicator to the server.

In the embodiment of the present disclosure, the processor is configured to receive an invite message with the second temporal ID and a user profile from the server and to control the display device to show an inviting figure and the user profile corresponding to the label of the second temporal ID.

In the embodiment of the present disclosure, the processor is configured to send an accepting message with a notification mode indicator to the server.

In the embodiment of the present disclosure, the processor is configured to control the display device to show an accepting figure and a user profile corresponding to the label of the second temporal ID after receiving an accepting message with the user profile from the server.

In the embodiment of the present disclosure, a sample pulse of the image sensor is narrower than the light pulse of first temporal ID from the light emitter.

In the embodiment of the present disclosure, the UE further comprises an image processor coupling between the image sensor and the processor.

In the embodiment of the present disclosure, the image processor is configured to control the image sensor to capture an image, detect the image, track the image and decode.

In the embodiment of the present disclosure, a method of detecting the image of the image processor comprises the steps of binarizing a data of the image, labeling the data of the image, extracting an area of a light spot, determining whether there has the same coordinate value in a tracking table, and going to the next process if the answer is Yes, or registering a coordinate value of the light spot relative to the whole image in a tracking table if the answer is No.

In the embodiment of the present disclosure, a method of tracking the image of the image processor comprises the steps of recording a pixel value of the light spot, estimating a position of a next light spot relative to the whole image, and determining whether the UE detecting 6 times of bright level successively or 6 times of dark level successively.

In the embodiment of the present disclosure, a method of decoding the image of the image processor comprises the steps of decoding bit of the image, checking whether every bit is decoded, and checking the parity if every bit is decoded, or returning to decoding bit step if not.

In the embodiment of the present disclosure, the step of decoding bit comprises the steps of searching ON signal on a bit data of the image, searching OFF signal on the bit data of the image, and setting a word to be 0 when a bit length between the ON signal and the OFF signal is less than or equal to 2, setting the word to be 1 when a bit length between the ON signal and the OFF signal is larger than or equal to 3 and less than or equal to 4, and setting the word to be error when a bit length between the ON signal and the OFF signal is larger than or equal to 5.

In the embodiment of the present disclosure, the step of searching ON signal comprises the step of finding bit of 1 after bit of 0, and the step of searching OFF signal comprises the step of finding bit of 0 after bit of 1, and the bit length between the ON signal and the OFF signal is the numbers of successive bit of 1.

Therefore, embodiments of the present invention provide a UE, a communication method and a communication system with Users able to view each other but do not know phone-number or IP-address to each other and do not want to reconnect after communicating.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram of a prior art communication system of SIP.

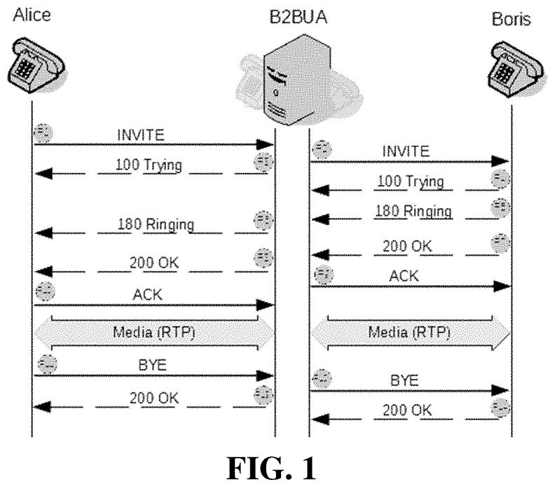

FIG. 2 is a schematic diagram of method of an image sensor communication of an user equipment (UE) with non-notification mode according to an embodiment of the present disclosure.

FIG. 3 is a schematic diagram of method of an image sensor communication of an user equipment (UE) with notification mode according to an embodiment of the present disclosure.

FIG. 4 is a schematic diagram of signal pulse and sampling pulse of an user equipment (UE) with notification mode according to an embodiment of the present disclosure.

FIG. 5 is a schematic diagram of communication between user equipment (UE) with block diagram of a UE according to an embodiment of the present disclosure.

FIG. 6 is a flowchart illustrating a processing flow of an image processor of a user equipment (UE) according to an embodiment of the present disclosure.

FIG. 7 is a flowchart illustrating a method of detecting process of an image processor according to an embodiment of the present disclosure.

FIG. 8 is a flowchart illustrating a method of tracking process of an image processor according to an embodiment of the present disclosure.

FIG. 9 is a flowchart illustrating a method of decoding process of an image processor according to an embodiment of the present disclosure.

FIG. 10 is a flowchart illustrating a method of bit decoding process of an image processor according to an embodiment of the present disclosure.

FIG. 11 is a schematic diagram of communication initiation between three or more user equipment (UE) according to an embodiment of the present disclosure.

FIG. 12 is a schematic diagram of how a communication between three or more user equipment (UE) preventing spoofing according to an embodiment of the present disclosure.

FIG. 13 is a schematic diagram of how a communication between three or more user equipment (UE) preventing spoofing according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

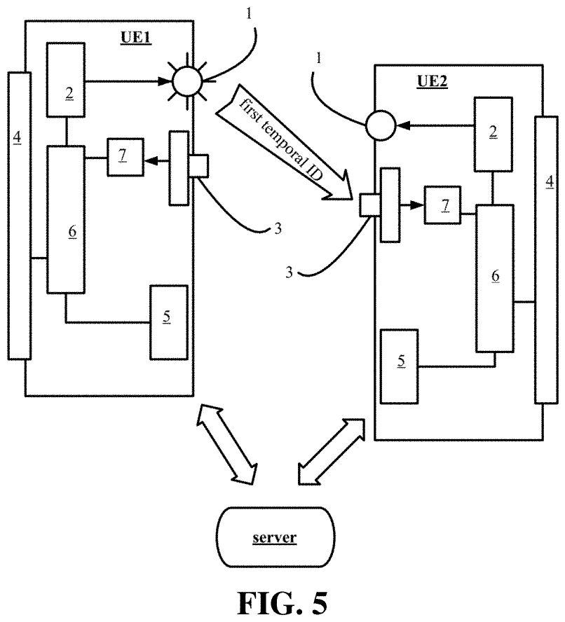

FIG. 5 illustrates that, in some embodiments, a user equipment (UE) UE1 includes a light emitter 1, a pulse driver 2 coupling to the light emitter 1, an image sensor 3, a display device 4, a transceiver 5, and a processor 6 coupling to the pulse driver 2, the image sensor 3, the transceiver 5, and the display device 4. The processor 6 is configured to control the pulse driver 2 to drive the light emitter 1 to send a first temporal identification data (ID) as a light pulse, control the image sensor 3 to receive a second temporal ID light pulse from UE2, control the transceiver 5 to transmit a communication message with the first temporal ID and the second temporal ID to a server in radio band or to receive the communication message with a second temporal ID in radio band, and compare the second temporal ID form the image sensor 3 and the second temporal ID form the transceiver 5 and control the display device 4 to show the communication message corresponding to the second temporal ID. UE1 and UE2 here are the same in structure but with different temporal identification data (ID).

Communication in radio band in this invention may be a mobile communication, a mobile internet communication, a walky-talky communication, et. al. The invention do not limit the system or equipment for communication in radio band, and do not limit the radio bands for communication.

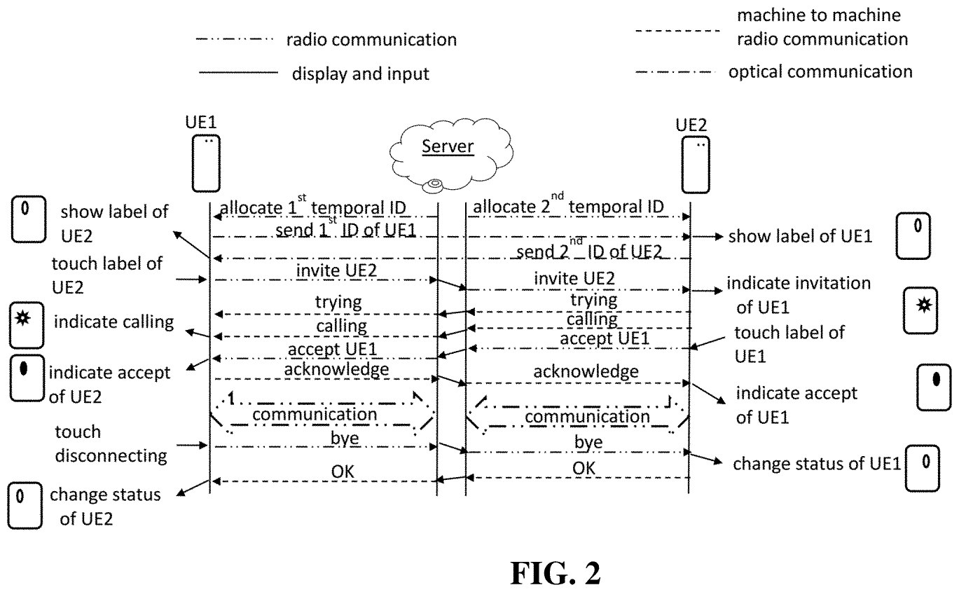

Please refer to FIG. 2 and FIG. 5. In some embodiments, the processor 6 of UE1 is configured to control the display device 4 to show a label corresponding to the second temporal ID when the image sensor 3 receives the second temporal ID light pulse from UE2.

The label in this invention maybe but not limit to a figure of a person, an icon, a name or any other data structure like drawing, picture, et. al.

In some embodiments, the transceiver 5 of UE1 is configured to receive the first temporal identification data (ID) allocated from a server.

In some embodiments, the processor 6 is configured to control the display device 4 of UE1 to show the communication message corresponding to the second temporal ID from the server when the second temporal ID form the transceiver 5 of UE1 matching the second temporal ID form the image sensor 3 of UE1.

In some embodiments, processor 6 of UE1 is configured to receive an inviting instruction of a user to send an inviting message with the first temporal ID and the second temporal ID to a server.

In some embodiments, processor 6 of UE2 is configured to receive an inviting message with the second temporal ID from the server.

In some embodiments, the processor 6 of UE2 is configured to control the display device 4 to show an inviting figure corresponding to the label of the first temporal ID, as shown in FIG. 2. On the other hand, the processor 6 of UE1 is configured to control the display device 4 to show an inviting figure corresponding to the label of the second temporal ID (not shown on the figure).

In some embodiments, the processor 6 of UE2 is configured to receive an accepting instruction of the user and to send an accepting message to the server after receiving the invite message with the first temporal ID from the server, as shown in FIG. 2. On the other hand, the processor 6 of UE1 is configured to receive an accepting instruction of the user and to send an accepting message to the server after receiving the invite message with the second temporal ID from the server (not shown on the figure).

In some embodiments, the processor 6 of UE1 is configured to control the display device 4 show an accepting figure corresponding to the label of the second temporal ID after receiving an accepting message from the server, as shown in FIG. 2. On the other hand, the processor 6 of UE2 is configured to control the display device 4 show an accepting figure corresponding to the label of the first temporal ID after receiving an accepting message from the server (not shown on the figure).

In some embodiments, the processor 6 of UE2 is configured to send a trying machine message and a calling machine message to the server when the processor 6 receiving an accepting instruction of the user, and the processor 6 of UE2 is configured to receive an acknowledge machine message from the server to establish a communication between the UE1 possessing the first temporal ID and UE2 possessing the second temporal ID, as shown in FIG. 2. On the other hand, the processor 6 of UE1 is configured to send a trying machine message and a calling machine message to the server when the processor 6 receiving an accepting instruction of the user, and the processor 6 of UE1 is configured to receive an acknowledge machine message from the server to establish a communication between the UE1 possessing the first temporal ID and UE2 possessing the second temporal ID (not shown on the figure).

In some embodiments, the processor 6 of UE1 is configured to receive a trying machine message and a calling machine message from the server, and the processor 6 of UE1 is configured to transmit a acknowledge machine message to the server to establish a communication between the UE1 possessing the first temporal ID and UE2 possessing the second temporal ID, as shown in FIG. 2. On the other hand, the processor 6 of UE2 is configured to receive a trying machine message and a calling machine message from the server, and the processor 6 of UE2 is configured to transmit a acknowledge machine message to the server to establish a communication between the UE1 possessing the first temporal ID and UE2 possessing the second temporal ID (not shown on the figure).

In some embodiments, the processor 6 of UE1 is configured to receive a disconnecting instruction of the user and to send a good-bye message to the server, as shown in FIG. 2. On the other hand, the processor 6 of UE2 is configured to receive a disconnecting instruction of the user and to send a good-bye message to the server (not shown on the figure).

In some embodiments, the processor 6 of UE2 is configured to receive a good-bye message from the server and to control the display device 4 to change the states of the label of the first temporal ID, as shown in FIG. 2. On the other hand, the processor 6 of UE1 is configured to receive a good-bye message from the server and to control the display device 4 to change the states of the label of the second temporal ID (not shown on the figure).

In some embodiments, the processor 6 of UE 2 is configured to transmit an OK machine message to the server after receiving the good-bye message, as shown in FIG. 2. On the other hand, the processor 6 of UE 1 is configured to transmit an OK machine message to the server after receiving the good-bye message (not shown on the figure).

In some embodiments, the processor 6 of UE1 is configured to control the display device 4 to change the states of the label of the second temporal ID after receiving an OK machine message from the server, as shown in FIG. 2. On the other hand, the processor 6 of UE2 is configured to control the display device 4 to change the states of the label of the first temporal ID after receiving an OK machine message from the server (not shown on the figure).

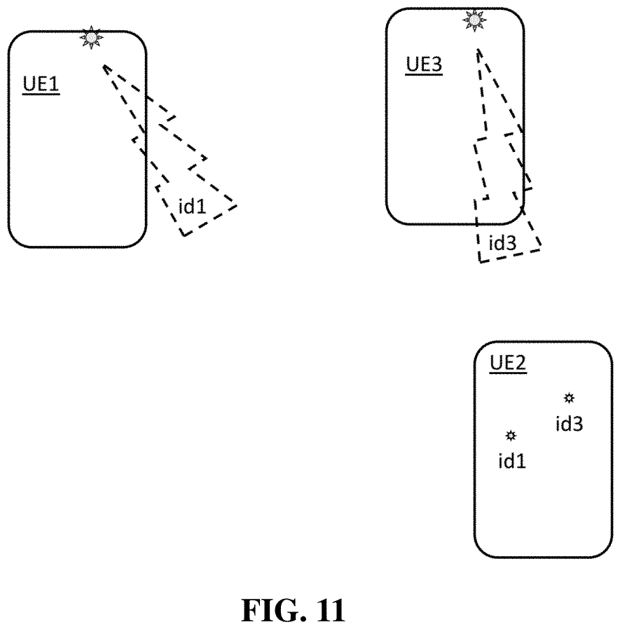

Please refer to FIG. 11. In some embodiments, the processor 6 of UE2 is configured to control the image sensor to receive a first temporal ID light pulse from the UE1, and a third temporal ID light pulse from a UE3 and to control the display device 4 to show a label correspond to the third temporal ID.

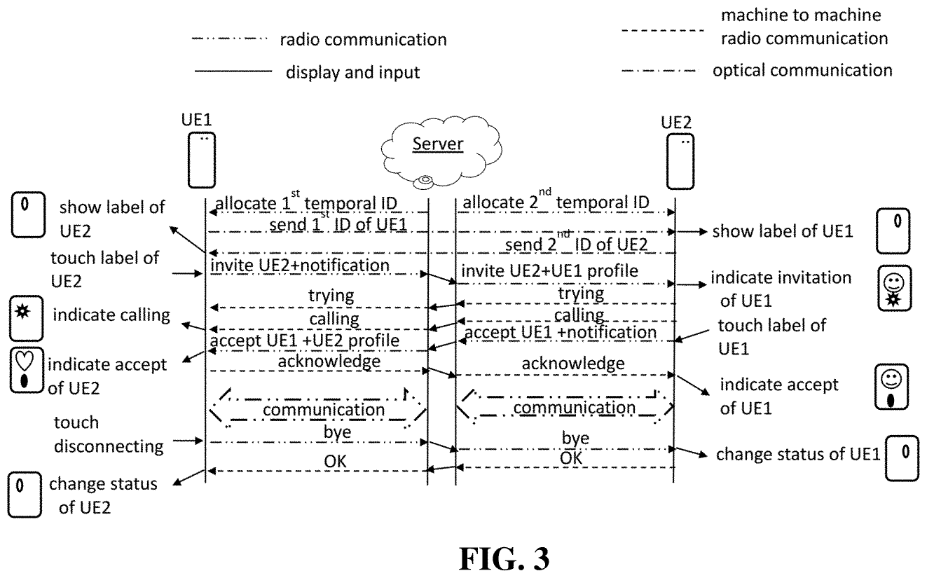

Please refer to FIG. 3. In some embodiments, the UE or the communication system has a notification mode, for example, the processor 6 of UE1 is configured to send the inviting message, the first temporal ID, and the second temporal ID accompanying with a notification mode indicator to the server, as shown in FIG. 3.

In some embodiments, the processor 6 of UE2 is configured to receive an invite message with the first temporal ID and a user profile of UE1 from the server and to control the display device 4 to show an inviting figure and the user profile corresponding to the label of the first temporal ID, as shown in FIG. 3. On the other hand, the processor 6 of UE1 is configured to receive an invite message with the second temporal ID and a user profile of UE2 from the server and to control the display device 4 to show an inviting figure and the user profile corresponding to the label of the second temporal ID (not shown on the figure).

In some embodiments, the processor 6 of UE2 is configured to send an accepting message with a notification mode indicator to the server.

In some embodiments, the processor 6 of UE1 is configured to control the display device 4 to show an accepting figure and a user profile corresponding to the label of the second temporal ID after receiving an accepting message with the user profile from the server.

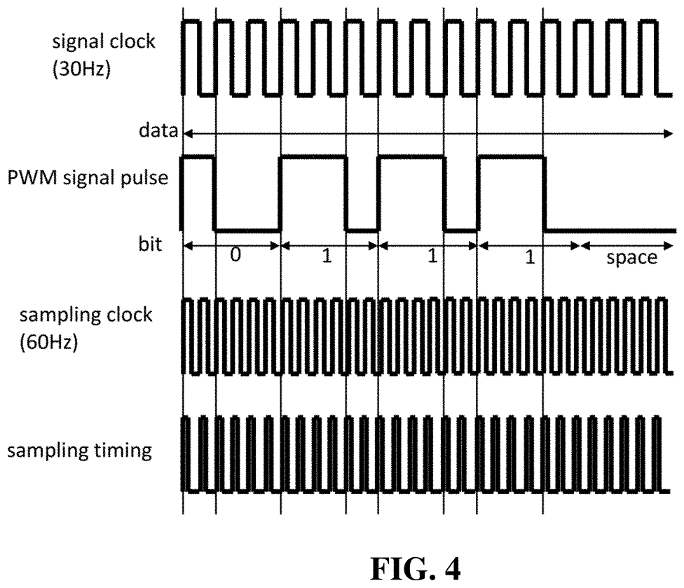

Please refer to FIG. 4. In some embodiments, a sample pulse of the image sensor 3 is narrower than the light pulse of first temporal ID or second temporal ID from the light emitter 1.

Please refer to FIG. 5. In some embodiments, the UE further comprises an image processor 7 coupling between the image sensor 3 and the processor 6.

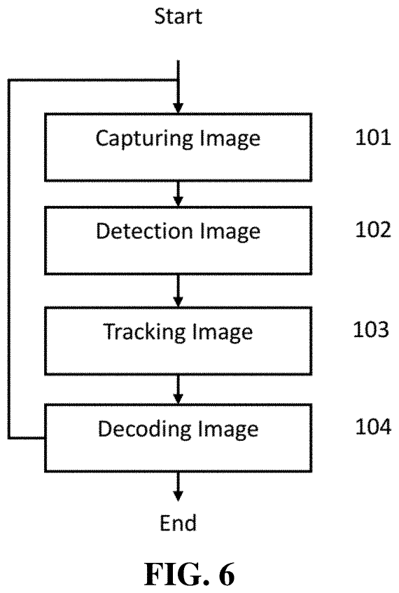

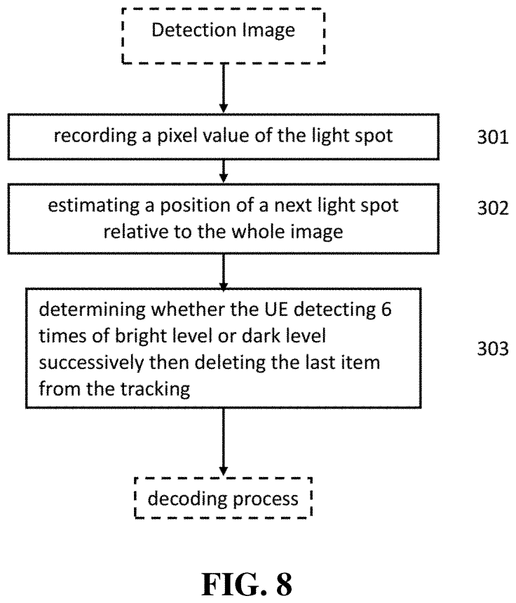

Please refer to FIG. 6 and FIG. 8. In some embodiments, the image processor 7 is configured to control the image sensor 3 to capture an image, detect the image, track the image and decode the image.

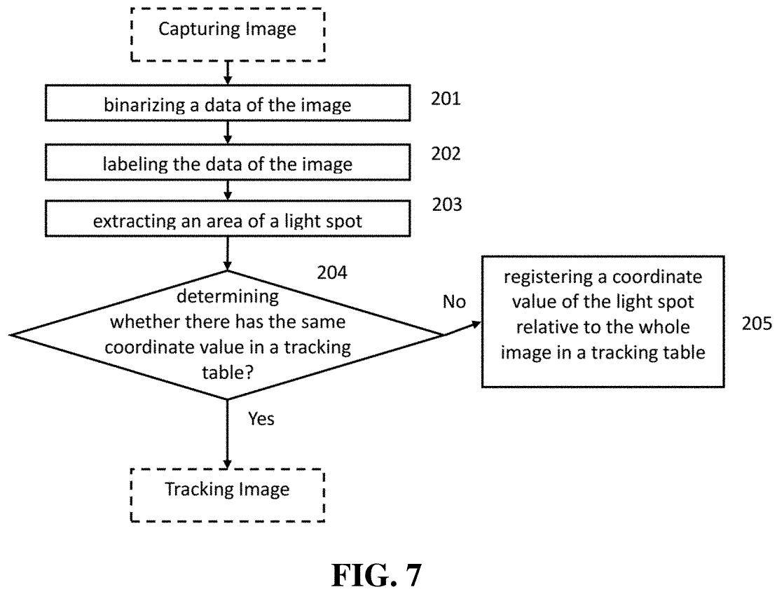

Please refer to FIG. 7. In some embodiments, a method of detecting the image of the image processor comprises the steps of: at block 201, binarizing a data of the image, at block 202, labeling the data of the image, at block 203, extracting an area of a light spot, at block 204, determining whether there has the same coordinate value in a tracking table, and going to the next process if the answer is Yes, or going to the block 205: registering a coordinate value of the light spot relative to the whole image in a tracking table if the answer is No.

Please refer to FIG. 8. In some embodiments, a method of tracking the image of the image processor comprises the steps of: at block 301, recording a pixel value of the light spot, at block 302, estimating a position of a next light spot relative to the whole image, at block 303, determining whether the UE detecting 6 times of bright level or dark level successively, and deleting the last item from the tracking.

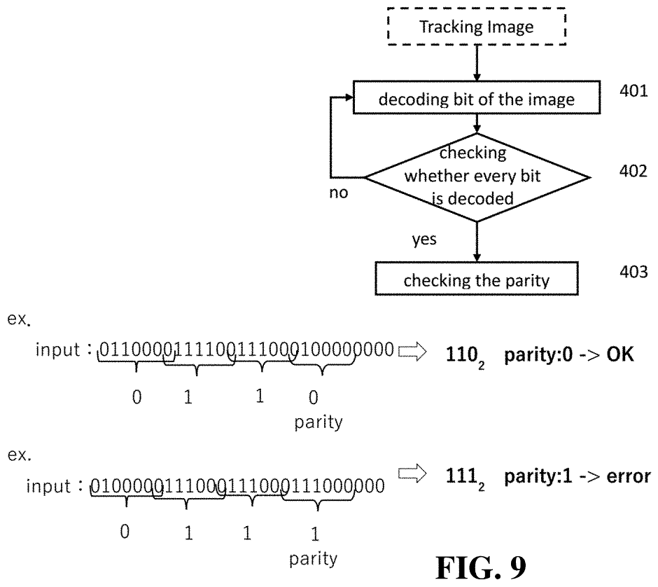

Please refer to FIG. 9. In some embodiments, a method of decoding the image of the image processor comprises the steps of: at block 401, decoding bit of the image, at block 402, checking whether every bit is decoded, and at block 403 checking the parity if every bit is decoded, or returning to block 401 if not.

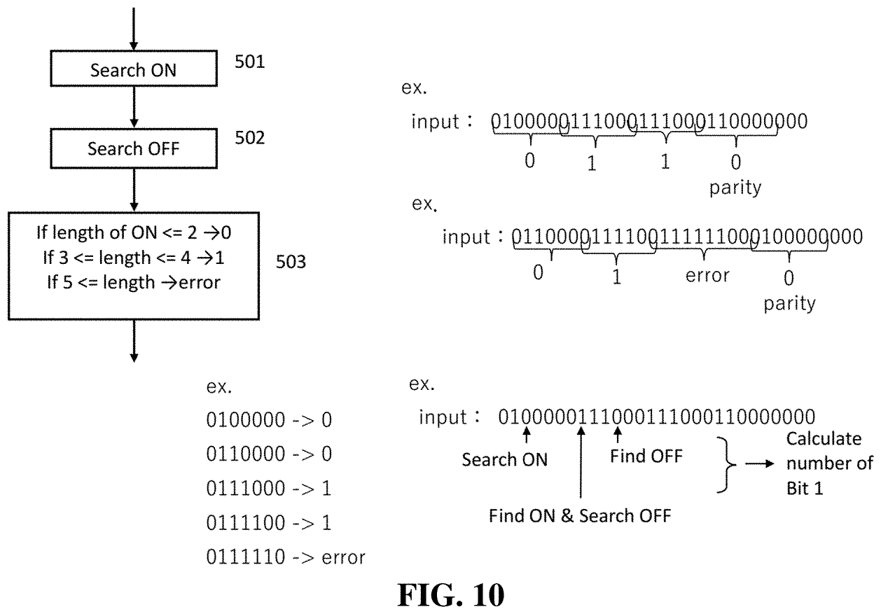

Please refer to FIG. 10, In some embodiments, the step of decoding bit comprises the steps of: at block 501, searching ON signal on a bit data of the image, at block 502, searching OFF signal on the bit data of the image, and at block 503, setting a word to be 0 when a bit length between the ON signal and the OFF signal is less than or equal to 2, setting the word to be 1 when a bit length between the ON signal and the OFF signal is larger than or equal to 3 and less than or equal to 4, and setting the word to be error when a bit length between the ON signal and the OFF signal is larger than or equal to 5.

In some embodiments, the step of searching ON signal comprises the step of finding bit of 1 after bit of 0, and the step of searching OFF signal comprises the step of finding bit of 0 after bit of 1, and the bit length between the ON signal and the OFF signal is the numbers of successive bit of 1.

Further, please refer to FIG. 2, in some embodiments, a method of an image sensor communication of a user equipment (UE) UE1 includes receiving a first temporal identification data (ID) allocated from a server, sending a first temporal ID as a light pulse, capturing a light pulse of a second temporal ID from UE2, showing a label on a display device corresponding to the second temporal ID, sending an inviting message with the first temporal ID and the second temporal ID to a server in radio band when receiving an inviting instruction of a user, and showing an accepting figure corresponding to the label of the second temporal ID on the display device after receiving an accepting message from the server.

In addition, in some embodiments, a method of an image sensor communication system of a user equipment (UE) UE1 with a server includes allocating a first temporal identification data (ID) to the UE1 by the server, receiving the first temporal ID by the UE1 in radio band, sending a first temporal ID as a light pulse by the UE1, capturing a light pulse of a second temporal ID from UE2 by the UE1, showing a label on a display device corresponding to the second temporal ID by the UE1, sending an inviting message with the first temporal ID and the second temporal ID by the UE1 to the server in radio band when receiving an inviting instruction of a user by the UE1, and showing an accepting figure corresponding to the label of the second temporal ID on the display device by the UE1 after receiving an accepting message from the server.

Please refer to FIG. 2. In addition, in some embodiments, a method of an image sensor communication system of a first user equipment (UE) UE1, a second user equipment UE2, and a server includes allocating a first temporal identification data (ID) to the UE1 by the server, allocating a second temporal identification data (ID) to the UE2 by the server, receiving the first temporal ID by the UE1 in radio band, receiving the second temporal ID by the UE2 in radio band, sending the first temporal ID as a light pulse by the UE1, capturing the light pulse of the first temporal ID by the UE2, sending the second temporal ID as a light pulse by the UE2, capturing the light pulse of the second temporal ID by the UE1, showing a label on a display device corresponding to the second temporal ID by the UE1, showing a label on a display device corresponding to the first temporal ID by the UE2, sending an inviting message with the first temporal ID and the second temporal ID to the server in radio band when receiving an inviting instruction of a user by the UE1, transmitting the inviting message with the first temporal ID to the UE2 by the server in radio band, showing an inviting figure corresponding to the label of the first temporal ID on the display device by the UE2, sending an accepting message to the server after receiving an accepting instruction of the user by the UE2, transmitting the accepting message to the UE1 by the server, and showing an accepting figure corresponding to the label of the second temporal ID on the display device by the UE1 after receiving an accepting message from the server.

In some embodiments, The method further comprises the steps of sending a trying machine message and a calling machine message to the server by the UE2, transmitting the trying machine message and the calling machine message to the UE1 by the server, receiving the trying machine message and the calling machine message from the server by the UE1, showing a calling figure corresponding to the label of the second temporal ID on the display device by the UE1, sending an acknowledge machine message to the server by the UE1, transmitting the acknowledge machine message to the UE2 by the server, receiving an acknowledge machine message from the server by the UE2, and establishing a communication between the UE1 and the UE2.

In some embodiments, the method of claim further comprises the steps of sending a good-bye message to the server after receiving a disconnecting instruction of the user by the UE1, transmitting the good-bye message to the UE2 by the server, receiving the good-bye message from the server and changing the states of the label of the first temporal ID on the display device by the UE2, sending an OK machine message to the server by the UE2, transmitting the OK machine message to the UE1 by the server, changing the states of the label corresponding to the second temporal ID by the UE1 after receiving the OK machine message from the server, and disconnecting the communication.

In some embodiments, the step of sending an inviting message with the first temporal ID and the second temporal ID to the server in radio band when receiving an inviting instruction of a user by the UE1 further comprising the step of sending a notification mode indicator accompanying with the inviting message, the first temporal ID, and the second temporal ID to the server by the UE1.

In some embodiments, the method further comprises the steps of, transmitting the invite message with the first temporal ID and a user profile to the UE2, receiving the invite message with the first temporal ID and the user profile from the server by the UE2, and showing an inviting figure and the user profile corresponding to the label of the first temporal ID on the display device by the UE2.

In some embodiments, the method further comprises the step of sending an accepting message with a notification mode indicator to the server by the UE2.

In some embodiments, the method further comprises the steps of, transmitting the accepting message with a user profile to the UE1 by the server, receiving the accepting message with the user profile from the server by the UE1, and showing an accepting figure and the user profile corresponding to the label of the second temporal ID on the display device by the UE1.

In some embodiments, a sample pulse of the step of capturing a light pulse of the first temporal ID by the UE2 or capturing the light pulse of the second temporal ID by the UE1 is narrower than the light pulse of the step of sending the first temporal ID as a light pulse by the UE1 or sending the second temporal ID as a light pulse by the UE2.

Please refer to FIG. 11. In some embodiments, the method further comprising the steps of capturing a third temporal ID light pulse from a UE3 by the UE2, and showing a label correspond to the third temporal ID on the display device by the UE2.

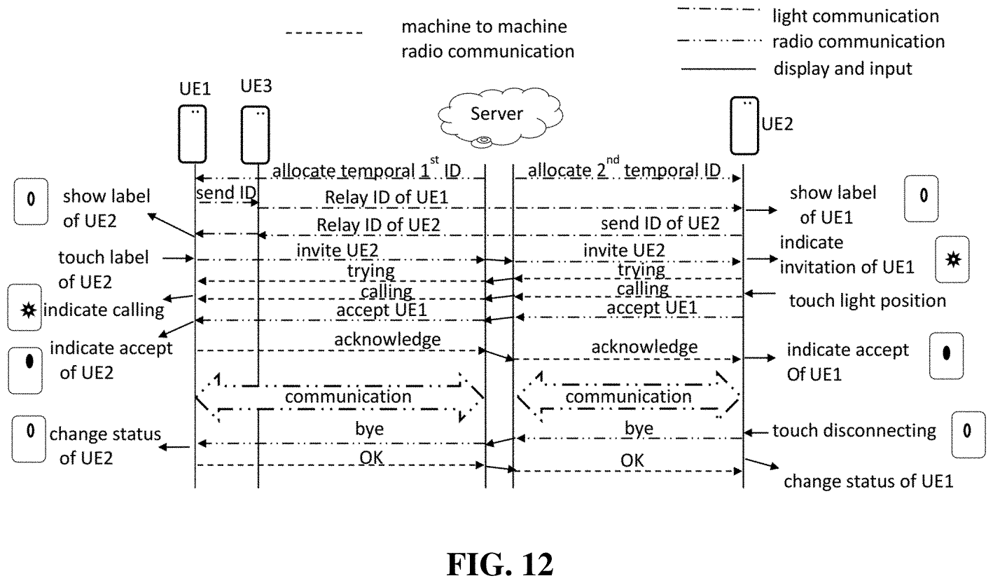

Please refer to FIG. 12. In some application, if someone near UE1 want to spoof, for example, UE3 relay the light pulse of first temporal ID to UE2, UE1 and UE2 can still communication in radio band without interruption of UE3.

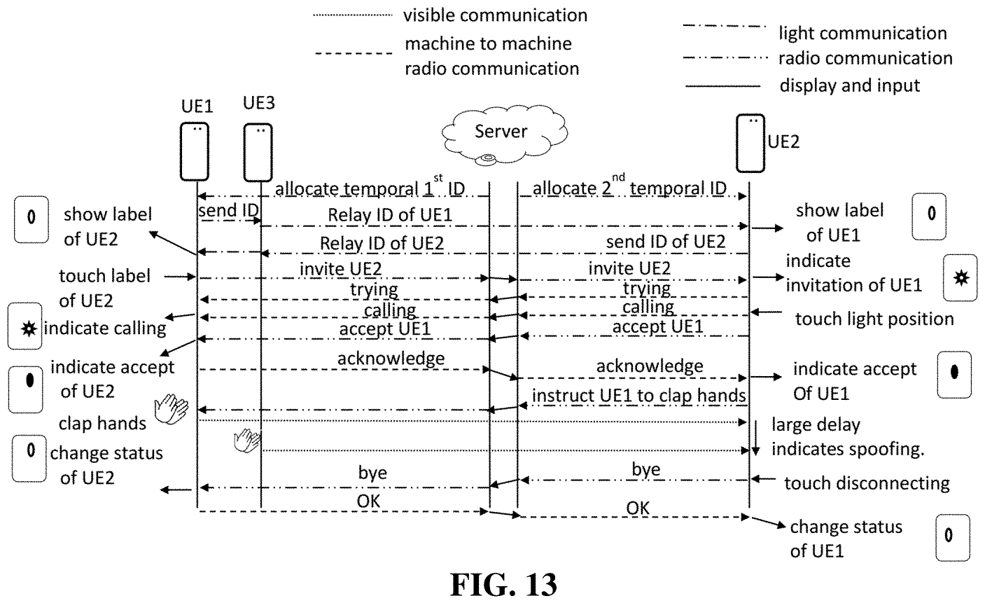

Please refer to FIG. 13. In some application, user of UE2 may ask user of UE1 to do something visual under the image sensor communication, for example, ask UE1 to clap hands via the communication in radio band. Then user of UE3 has no way to know this requirement to response or he may guess and do the same thing following user of UE1. User of UE2 may recognize who is communicating with him.

The embodiments aim to provide a UE, a communication method and a communication system with Users able to view each other but do not know phone-number or IP-address to each other and do not want to reconnect after communicating.

Benefits of communication via optical signal and radio band include:

1. raising the communication speed via radio band under the image sensor communication.

2. enhancing the safety of communication by preventing spoofing.

In the embodiment of the present disclosure, a user equipment (UE), and a method of an image sensor communication of same are provided. The method of an image sensor communication of the UE includes receiving a first temporal identification data (ID) allocated from a server, sending a first temporal ID as a light pulse, capturing a light pulse of a second temporal ID from another UE, showing a label on a display device corresponding to the second temporal ID, sending an inviting message with the first temporal ID and the second temporal ID to a server in radio band when receiving an inviting instruction of a user, and showing an accepting figure corresponding to the label of the second temporal ID on the display device after receiving an accepting message from the server, so as to provide a simple, fast, and safety UE, communication method and communication system with users able to view each other but do not know phone-number or IP-address to each other and do not want to reconnect after communicating.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment (UE) in an image sensor communication system, the UE comprising:
a light emitter;
a pulse driver coupling to the light emitter;
an image sensor;
a display device;
a transceiver; and
a processor coupling to the pulse driver, the image sensor, the transceiver, and the display device,
wherein the processor is configured to:
control the pulse driver to drive the light emitter to send a first temporal identification data (ID) as a light pulse;
control the image sensor to receive temporal IDs light pulses from another UEs;
control the transceiver to transmit a communication message with the first temporal ID and one of the temporal IDs of another UEs to a server in radio band or to receive the communication message with the temporal ID of another UE in radio band; and
compare the second temporal ID from the image sensor and the second temporal ID from the transceiver and control the display device to show the communication message corresponding to the second temporal ID.

2. The UE of claim 1, wherein the processor is configured to control the display device to show labels corresponding to the temporal IDs when the image sensor receives the temporal IDs light pulses from another UEs.

3. The UE of claim 1, wherein the transceiver is configured to receive the first temporal identification data (ID) allocated from a server.

4. The UE of claim 1, wherein the processor is configured to control the display device to show the communication message corresponding to the second temporal ID when the second temporal ID from the transceiver matching the second temporal ID from the image sensor.

5. The UE of claim 1, wherein a sample pulse of the image sensor is narrower than the light pulse of first temporal ID from the light emitter.

6. The UE of claim 1, wherein the processor is configured to control the image sensor to receive a third temporal ID light pulse from a second another UE and to control the display device to show a label correspond to the third temporal ID.

7. The UE of claim 1, further comprising an image processor coupling between the image sensor and the processor,
wherein the image processor is configured to:
control the image sensor to capture an image;
detect the image;
track the image; and
decode the image.

8. A method of an image sensor communication of a user equipment (UE), the method comprising:
receiving a first temporal identification data (ID) allocated from a server;
sending a first temporal ID as a light pulse;
capturing light pulses of a temporal IDs from another UEs;
showing labels on a display device corresponding to the temporal IDs of another UEs;
sending an inviting message with the first temporal ID and one of the temporal IDs of another UEs to a server in radio band when receiving an inviting instruction of a user; and
showing an accepting figure corresponding to the label of the temporal ID of another UE invited by the user on the display device after receiving an accepting message from the server.

9. The method of claim 8, further comprising the steps of:
receiving a trying machine message and a calling machine message from the server, and transmitting a acknowledge machine message to the server to establish a communication between the UE and another UE invited by the user; and
showing a calling figure corresponding to the label of the temporal ID of another UE invited by the user on the display device after receiving a calling machine message from the server.

10. The method of claim 9, further comprising the steps of:
sending a good-bye message to the server after receiving a disconnecting instruction of the user;
changing the states of the label corresponding to the temporal ID of another UE invited by the user after receiving an OK machine message from the server; and
disconnecting the communication.

11. The method of claim 8, further comprising the steps of:
receiving an inviting message with a temporal ID of another UE from the server; and
showing an inviting figure corresponding to the label of the temporal ID of another UE on the display device.

12. The method of claim 8, further comprising the steps of:
sending an accepting message to the server after receiving an accepting instruction of the user;
sending a trying machine message and a calling machine message to the server; and
receiving an acknowledge machine message from the server to establish a communication between the UE and another UE invited by the user.

13. The method of claim 8, further comprising the steps of:
receiving a good-bye message from the server and changing the states of the label of the temporal ID of another UE on the display device;
transmitting an OK machine message to the server; and
disconnecting the communication.

14. The method of claim 8, wherein the step of sending an inviting message with the first temporal ID and the temporal ID of another UE to a server in radio band when receiving an inviting instruction of a user further comprising the step of sending a notification mode indicator accompanying with the inviting message, the first temporal ID, and the temporal ID of another UE to the server.

15. The method of claim 8, further comprising the steps of:
sending an accepting message with a notification mode indicator to the server;
receiving an accepting message with a user profile from the server; and
showing an accepting figure and the user profile corresponding to the label of the temporal ID of another UE on the display device.

16. The method of claim 8, wherein a sample pulse of the step of capturing light pulses of temporal IDs from another UEs is narrower than the light pulse of the step of sending a first temporal ID.

17. The method of claim 8, further comprising the steps of:
receiving a second temporal ID light pulse from a second UE; and
showing a label correspond to the second temporal ID on the display device.

18. The method of claim 8, wherein the step of capturing light pulses of temporal IDs from another UEs further comprises the steps of:
capturing an image;
detecting the image;
tracking the image; and
decoding the image.

19. The method of claim 18, wherein the step of detecting the image comprises the steps of:
binarizing a data of the image;
labeling the data of the image;
extracting an area of a light spot;
determining whether there has the same coordinate value in a tracking table; and
going to the next process if the answer is Yes, or registering a coordinate value of the light spot relative to the whole image in a tracking table if the answer is No,
wherein the step of tracking the image comprises the steps of:
recording a pixel value of the light spot;
estimating a position of a next light spot relative to the whole image; and
determining whether the UE detecting 6 times of bright level successively or 6 times of dark level successively,
wherein the step of decoding the image comprises the steps of:
decoding bit of the image;
checking whether every bit is decoded; and
checking the parity if every bit is decoded, or returning to decoding bit step if not.

20. The method of claim 19, wherein the step of decoding bit of the image comprises the steps of:
searching ON signal on a bit data of the image;
searching OFF signal on the bit data of the image; and
setting a word to be 0 when a bit length between the ON signal and the OFF signal is less than or equal to 2, setting the word to be 1 when a bit length between the ON signal and the OFF signal is larger than or equal to 3 and less than or equal to 4, and setting the word to be error when a bit length between the ON signal and the OFF signal is larger than or equal to 5,
wherein the step of searching ON signal comprises the steps of finding bit of 1 after bit of 0, and the step of searching OFF signal comprises the step of finding bit of 0 after bit of 1, and the bit length between the ON signal and the OFF signal is the numbers of successive bit of 1.
